(19) United States
(12) Patent Application Publication
(10) Pub. No.: US 2018/0211606 A1
(43) Pub. Date: Jul. 26, 2018

(54) SHIFT REGISTER CIRCUIT AND DRIVING METHOD THEREFOR, GATE LINE DRIVING CIRCUIT AND ARRAY SUBSTRATE

(71) Applicants: BOE TECHNOLOGY GROUP CO., LTD., Beijing (CN); BEIJING BOE DISPLAY TECHNOLOGY CO., LTD., Beijing (CN)

(72) Inventors: Xiaoxiang ZHANG, Beijing (CN); Zheng LIU, Beijing (CN); Huibin GUO, Beijing (CN); Mingxuan LIU, Beijing (CN)

(21) Appl. No.: 15/742,723

(22) PCT Filed: May 26, 2017
(86) PCT No.: PCT/CN2017/086071

§ 371 Date: Jan. 8, 2018

(30) Foreign Application Priority Data
May 30, 2016 (CN) 201610371835.7

(51) Int. Cl. G09G 3/34

(52) U.S. Cl. CPC G09G 3/34; G09G 2310/0286

(57) ABSTRACT

A shift register circuit and a driving method therefor, a gate line driving circuit and an array substrate, the shift register circuit includes: a charging sub-circuit for charging a pull-up node under the control of a signal input by an input signal terminal; an output sub-circuit for outputting, through an output terminal, a clock signal provided by a first clock signal terminal to serve as a drive signal, under control of an electric level of the pull-up node; a first pull-down sub-circuit for pulling down the pull-up node and the output terminal under the control of an electric level of a first pull-down node; and a reset sub-circuit for resetting the pull-up node and the output terminal under the control of a reset signal input by a reset signal terminal.

### TECHNICAL FIELD

The present disclosure relates to the technical field of display technology, and more particularly to a shift register unit, a driving method for the shift register unit, a gate line driving circuit comprising the shift register unit, and an array substrate comprising the gate line driving circuit.

### BACKGROUND

In the field of display technology, an array of pixels of a liquid crystal display typically includes a plurality of rows of gate lines and a plurality of columns of data lines crossed with each other, wherein driving of the gate lines can be implemented through an attached integrated driving circuit. In recent years, with continuous advancement of the amorphous silicon thin film manufacturing process, a gate driving circuit can also be integrated on a thin film transistor array substrate so as to form a GOA (Gate driver On Array) for driving the gate lines.

Usually, a plurality of stages of shift register units can be adopted to form the GOA to provide switching signals to a plurality of rows of gate lines of a pixel array, so as to control the plurality of rows of gate lines to be turned on sequentially, and the data lines apply display data signals to pixels in the corresponding rows in the pixel array, so as to form grayscale voltages required to display respective gray scales of an image, and then each frame of the image is displayed.

During the process of driving gate lines by using the GOA, in a turn-off period of the gate lines, that is, in a low voltage level maintaining period, due to presence of a coupling capacitance Cp of an output TFT in the corresponding shift register unit, potentials at a pull-up node PU and an output terminal in the shift register unit are easily affected by a high level of a clock signal to which the output TFT is connected. In particular, under a high-temperature operating condition, a threshold voltage Vth of the output TFT drifts, which affecting the pull-up node PU and the output terminal more seriously. As a result, an abnormal signal occurs at corresponding gate lines in the turn-off period, which may render an operating state of the pixel unit to which the gate lines are connected abnormal, thereby decreasing the display quality of the display panel.

### SUMMARY

In view of the above problems, the present disclosure provides a shift register unit, a driving a driving method for the shift register unit, a gate line driving circuit, and an array substrate, so that during the low voltage level maintaining period in the driving process of the shift register unit, a first pull-down sub-circuit can be used to pull down the pull-up node PU and the output terminal OUT so as to eliminate the noise due to the presence of the coupling capacitance.

According to an aspect of the present disclosure, there is provided a shift register unit, comprising: a charging sub-circuit connected with an input signal terminal and a pull-up node, and configured to charge the pull-up node under control of a signal inputted at the input signal terminal; an output sub-circuit connected with the pull-up node, a first clock signal terminal and an output terminal, and configured to output, via the output terminal, a clock signal provided by the first clock signal terminal as a driving signal under control of a voltage level at the pull-up node; a first pull-down sub-circuit connected with the pull-up node, the output terminal and a first pull-down node, and configured to pull down the pull-up node and the output terminal under control of a voltage level at the first pull-down node; a reset sub-circuit connected with the pull-up node, the output terminal and a reset signal terminal, and configured to reset the pull-up node and the output terminal under control of a reset signal inputted at the reset signal terminal; and a first control sub-circuit connected with the pull-up node, the first clock signal terminal and the first pull-down node, and configured to control a voltage level at the first pull-down node under control of voltage levels at the pull-up node and the first clock signal terminal.

According to another aspect of the present disclosure, there is provided a gate line driving circuit, comprising a plurality of stages of the shift register unit as described above.

According to still another aspect of the present disclosure, there is provided an array substrate, comprising the gate line driving circuit as described above.

According to still another aspect of the present disclosure, there is provided a driving method applied to the shift register unit as described above, the driving method comprising: inputting an active voltage level to the input signal terminal, charging the pull-up node to a first high voltage level, and turning on the output sub-circuit; outputting, via the output sub-circuit, a first clock signal with a high voltage level to a gate line as a driving signal; inputting an active reset voltage level to the reset signal terminal, discharging the pull-up node and the output terminal and pull down the same to a low voltage level, and turning off the output sub-circuit; and inputting the first clock signal with a high voltage level, turning on the first pull-down sub-circuit, maintaining the pull-up node and the output terminal at a low voltage level until a next active voltage level is inputted at the input signal terminal.

### BRIEF DESCRIPTION OF THE DRAWINGS

In order to more clearly illustrate the technical solutions of the embodiments of the present disclosure, hereinafter, the drawings necessary for illustration of the embodiments of the present application will be introduced briefly; obviously, the drawings described below only illustrate some embodiments of the present disclosure, and should not be construed as limiting the present disclosure in any way.

FIG. 1 illustrates a circuit structure of a known shift register unit;

FIG. 2 illustrates relevant signal timings available for this known shift register unit;

FIG. 3 is a block diagram of a shift register unit according to an embodiment of the present disclosure;

FIG. 4 illustrates a circuit structure of a shift register unit according to an embodiment of the present disclosure;

FIG. 5 illustrates relevant signal timings available for the shift register unit illustrated in FIG. 4;

FIG. 6 is a block diagram of a shift register unit according to another embodiment of the present disclosure;

FIG. 7 is a circuit structure of a shift register unit according to another embodiment of the present disclosure;

FIG. 8 illustrates relevant signal timings available for the shift register unit illustrated in FIG. 7;

FIG. 9 is a schematic diagram of a connection structure of a gate line driving device according to an embodiment of the present disclosure; and

FIG. 10 is a flowchart of a driving method applied to a shift register unit according to an embodiment of the present disclosure.

### DETAILED DESCRIPTION OF THE EMBODIMENTS

Hereinafter, technical solutions in the embodiments of the present disclosure will be described clearly and comprehensively in combination with the drawings. Obviously, these described embodiments are merely parts of the embodiments of the present disclosure, rather than all of the embodiments thereof. Other embodiments obtained by the ordinary skill in the art based on the embodiments of the present disclosure without paying creative effort all fall into the protection scope of the present disclosure.

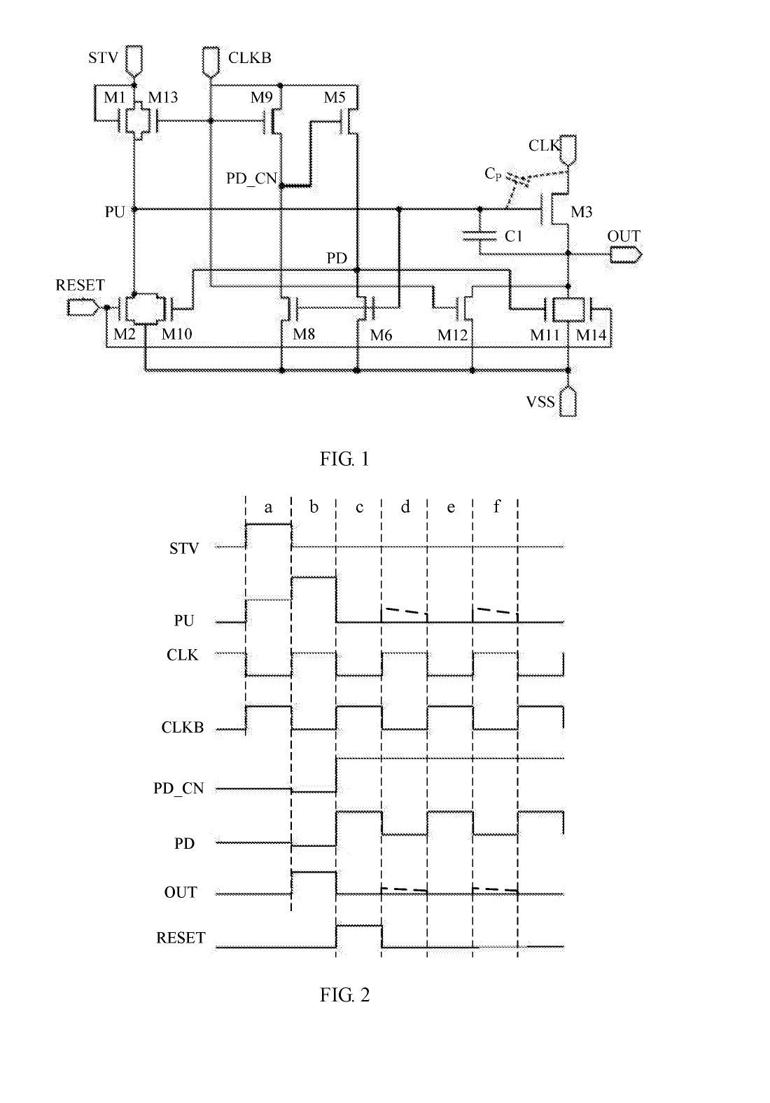

FIG. 1 illustrates a circuit structure of a known shift register unit. As illustrated in FIG. 1, the shift register unit comprises: an input transistor M1 having a gate and a drain connected together and connected with an input terminal of the shift register unit, and a source connected with a pull-up node PU; an output transistor M3 having a gate connected with the pull-up node PU, a drain connected with a first clock signal terminal CLK, and a source connected with an output terminal of the shift register unit; a capacitor C1 connected between the gate and the source of the output transistor M3; a pull-up node reset transistor M2 having a gate connected with a reset terminal of the shift register unit, a drain connected with the pull-up node, and a source connected with a low voltage level input terminal VSS; an output reset transistor M14 having a gate connected with the reset terminal of the shift register unit, a drain connected with the output terminal of the shift register unit, and a source connected with the low voltage level input terminal VSS; a pull-up node voltage level control transistor M10 having a gate connected with a pull-down node PD, a drain connected with the pull-up node PU, and a source connected with the low voltage level input terminal VSS; output terminal voltage level control transistors M11 and M12, the transistor M11 having a gate connected with the pull-down node PD, a drain connected with the output terminal of the shift register unit, a source connected to the low voltage level input terminal VSS, the transistor M12 having a gate connected to a second clock signal terminal CLKB, a drain connected to the output terminal of the shift register unit, and a source connected to the low voltage level input terminal VSS; a transistor M13 having a gate connected with the second clock signal terminal, a drain connected with the input terminal of the shift register unit, and a source connected with the pull-up node; a pull-down node control module including transistors M9, M5, M8 and M6, the transistor M9 having a gate and drain connected with the second clock signal terminal, a source connected with the pull-down control node PD_CN, the transistor M5 having a gate connected with the pull-down control node PD_CN, a drain connected with the second clock signal terminal, a source connected with the pull-down node PD, the transistor M8 having a drain connected with the pull-down control node PD_CN, a gate connected with the pull-up node PU, a source connected with the low voltage level input terminal VSS, the transistor M6 having a gate connected with the pull-up node PU, a drain connected with the pull-down node PD, and a source connected with the low voltage level input VSS.

The operating principle of the shift register unit illustrated in FIG. 1 will be described below with reference to the signal timings illustrated in FIG. 2. In the five periods illustrated by a, b, c, d, and e in FIG. 2, the shift register unit performs the following operations.

In the first period a, the clock signal CLK inputted at the first clock signal input terminal is at a low voltage level, the clock signal CLKB inputted at the second clock signal terminal is at a high voltage level, and an input signal connected at the input terminal INPUT is at a high voltage level; it should be noted that, in a case in which the shift register unit illustrated in FIG. 1 serves as the first stage, its input terminal is connected with a frame start signal STV; since a high voltage level is inputted at the input terminal, the transistor M1 is turned on, so that the input signal with a high voltage level charges the pull-up node PU; since the second clock signal CLKB is at a high voltage level, the transistor M13 is turned on, the charging process of the pull-up node PU is accelerated; thus, the pull-up node PU is charged to a first high voltage level, and the output transistor M3 is turned on, so as to output the clock signal CLK with a low voltage level to the output terminal; the transistor M9 is turned on to charge the pull-down control node PD_CN; however, since the pull-up node PU is at a first high voltage level, the transistors M6 and M8 are turned on; in design of transistors, a size ratio of the transistors M8 and M9 can be configured in such a way that the voltage level at the pull-down control node PD_CN is pulled down to a low voltage level when M9 and M8 are both turned on, in this case, PD_CN is at a low voltage level and the transistor M5 remains off; since the transistor M6 is turned on, the voltage level at the pull-down node PD is pulled down to a low voltage level, so that the transistors M10 and M11 are in a turned-off state in this period; since CLKB is at a high voltage level, the transistor M12 is turned on, and thereby it can be ensured that the output terminal of the shift register unit is pulled down to a low voltage level VSS.

In the second period b, the clock signal CLK inputted at the first clock signal terminal is at a high voltage level, the clock signal CLKB inputted at the second clock signal terminal is at a low voltage level, and the signal inputted at the input terminal INPUT is at a low voltage level; the transistors M1, M13, M9, M5 and M12 are turned off; the output transistor M3 is turned on to output the clock signal CLK at a high voltage level as a gate line driving signal; due to bootstrap effect of the storage capacitor C1, the voltage level at the pull-up node PU is further increased to reach a second high voltage level, so that the output transistor M3 is turned on more fully; since the voltage level at the pull-up node PU is raised relative to the voltage level in the period a, the transistors M8 and M6 are turned on more fully, the pull-down control node PD_CN and the pull-down node PD are further pulled down, respectively; since the pull-down node PD is at a low voltage level, the transistors M10 and M11 are maintained in a turned-off state so as not to affect the shift register unit to output the gate line driving signal normally.

In the third period c, the clock signal CLK inputted at the first clock signal terminal is at a low voltage level, the clock signal CLKB inputted at the second clock signal terminal is at a high voltage level, the input terminal INPUT continues to input a low voltage level, and the reset terminal RESET is connected with a high voltage level; since the reset terminal is connected with a high voltage level, the transistors M2 and M14 are turned on, the pull-up node PU and the output terminal of the shift register unit are pulled down to a low voltage level VSS, respectively; the transistor M1 is turned off, the transistor M13 is turned on, a low voltage level is connected with the pull-up node PU to discharge the pull-up node PU; the pull-up node PU is discharged to a low voltage level, the transistor M3 is turned off; since the second clock signal CLKB is at a high voltage level, the transistor M12 is turned on, the output terminal of the shift register unit is pulled down to a low voltage level VSS; the transistor M9 is turned on to charge the pull-down control node PD_CN, so that the transistor M5 is turned on to charge the pull-down node PD; since the pull-up node PU is at a low voltage level, the transistors M6 and M8 are turned off; the pull-down node PD is charged to a high voltage level, the transistors M10 and M11 are turned on, the pull-up node PU and the output terminal of the shift register unit are pulled down to a low voltage level VSS, respectively.

In the fourth period d, the clock signal CLK inputted at the first clock signal terminal is at a high voltage level, the clock signal CLKB inputted at the second clock signal terminal is at a low voltage level, the input terminal INPUT continues to be connected with a low voltage level, the reset terminal is connected with a low voltage level; the transistors M1, M13, M2, M14, M9 and M12 are turned off; since the pull-up node PU is maintained at a low voltage level, the transistors M6 and M8 continue to be turned off; since the transistors M8 and M9 are both turned off, a discharge path of the pull-down control node PD_CN is cut, the pull-down control node PD_CN maintains the previous high voltage level, so that the transistor M5 remains on, and since the second clock signal CLKB is at a low voltage level, the pull-down node PD is discharged. Since the pull-down node PD is at a low voltage level, the transistors M10 and M11 are turned off, a discharge path of the pull-up node and a discharge path of the output terminal of the shift register unit are cut, respectively, and thus the pull-up node PU and the output terminal are in a floating state. It should be noted that, in this period, the shift register unit is in a non-output period, both the pull-up node PU and the output terminal should be maintained in the previous low voltage level state; however, since the first clock signal CLK is at a high voltage level, and as illustrated in FIG. 1, there is a coupling capacitance Cp between the gate and the drain of the output transistor M3, so that the high voltage level of the first clock signal CLK may be coupled to the pull-up node PU via the coupling capacitance Cp to form a noise, which finally results in that the transistor M3 is slightly turned on, and a noise is generated at the output terminal; in this regard, reference can be made to the waveform indicated by the broken line in the timing diagram of FIG. 2.

In the fifth period e, the clock signal CLK inputted at the first clock signal terminal is at a low voltage level, the clock signal CLKB inputted at the second clock signal terminal is at a high voltage level, the input terminal INPUT continues to be connected with a low voltage level, the reset terminal is connected with a low voltage level; the transistors M1, M2 and M14 are turned off; the transistor M13 is turned on, a low voltage level is connected with the pull-up node PU to discharge the pull-up node PU, and thereby it is ensured that the transistor M3 is turned off; CLKB is at a high voltage level, the transistor M12 is turned on, the output terminal of the shift register unit is pulled down to a low voltage level VSS, to eliminate the noise at the output terminal of the shift register unit; the transistor M9 is turned on to charge the pull-down control node PD_CN, so that the transistor M5 is turned on more fully, and the pull-down node PD is charged, so that the pull-down node PD becomes to be at a high voltage level; since the pull-up node PU is discharged, the transistors M6 and M8 are turned off; the high voltage level at the pull-down node PD enables the transistors M10 and M11 to be turned on, and the pull-up node PU and the output terminal of the shift register unit are pulled down to a low voltage level VSS, respectively, which eliminates noise generated at the pull-up node and the output terminal.

Thereafter, the shift register unit repeats the operations in periods d and e until a next active input signal arrives.

As can be seen, in the shift register unit described above, due to presence of the coupling capacitance Cp in the shift register unit, in the non-output period of the shift register unit, particularly in the low voltage level maintaining period (e.g., the period d illustrated in FIG. 2), potentials at the pull-up node PU and the output terminal in the shift register unit are easily affected by a high voltage level of the clock signal to which the output transistor M3 is connected. In particular, under a high-temperature operating condition, a threshold voltage Vth of the output TFT drifts, which affects the pull-up node PU and the output terminal more seriously. As a result, the corresponding gate lines might have an abnormal signal in the turn-off period, which may render an operating state of the pixel unit connected with the gate line abnormal, thereby decreasing the display quality of the display panel.

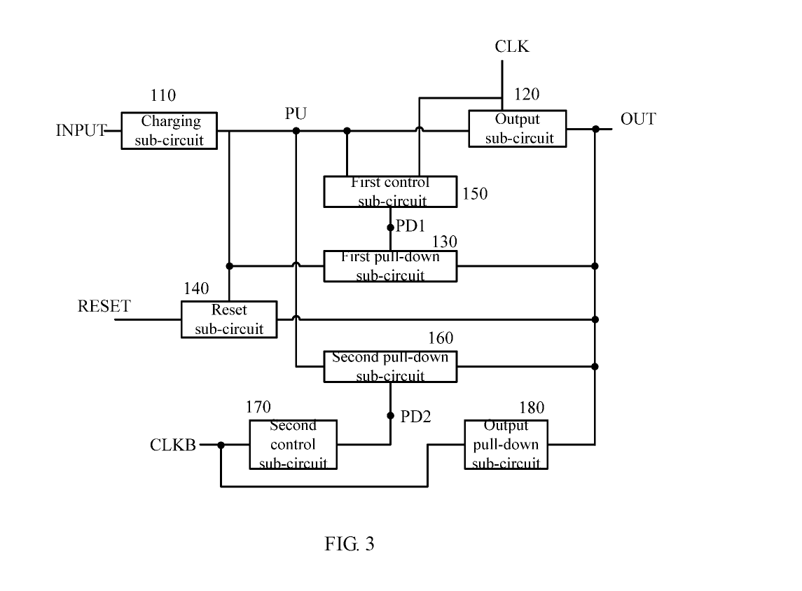

In view of this, according to an aspect of the present disclosure, a shift register unit is provided. As illustrated in FIG. 3, the shift register unit comprises a charging sub-circuit 110 connected with an input signal terminal INPUT and a pull-up node PU, and configured to charge the pull-up node PU under control of a signal inputted at the input signal terminal; an output sub-circuit 120 connected with the pull-up node PU, a first clock signal terminal CLK and an output terminal OUT, and configured to output, via the output terminal OUT, a clock signal provided by the first clock signal terminal CLK as a driving signal under control of a voltage level at the pull-up node PU; a first pull-down sub-circuit 130 connected with the pull-up node PU, the output terminal OUT and a first pull-down node PD1, and configured to pull down the pull-up node PU and the output terminal OUT under control of a voltage level at the first pull-down node PD1; and a reset sub-circuit 140 connected with the pull-up node PU, the output terminal OUT and a reset signal terminal RESET, and configured to reset the pull-up node PU and the output terminal OUT under control of a reset signal inputted at the reset signal terminal.

In the above-described shift register unit according to the present disclosure, since the first pull-down sub-circuit 130 is configured, in the low voltage level maintaining period of the driving process of the shift register unit, the pull-up node PU and the output terminal OUT can be pulled down according to the voltage level at the first pull-down node PD1, which eliminates the noise due to the presence of the coupling capacitance, and thereby it is ensured that a correct driving signal is outputted to the gate line connected with the shift register unit, guaranteeing the quality of the pixel display.

Optionally, as illustrated in FIG. 3, the shift register unit further comprises a first control sub-circuit 150 connected with the pull-up node PU, the first clock signal terminal CLK and the first pull-down node PD1, and configured to control a voltage level at the first pull-down node PD1 under control of voltage levels at the pull-up node PU and the first clock signal terminal CLK.

Accordingly, the voltage level at the first pull-down node PD1 can be controlled by the first clock signal CLK, so that when the CLK outputs a high voltage level and the pull-up node PU is at a low voltage level, the voltage level at the first pull-down node PD1 is pulled up, so as to turn on the first pull-down sub-circuit, thereby eliminating the noises at the pull-up node PU and the output terminal due to the coupling capacitance.

Optionally, as illustrated in FIG. 3, the shift register unit further comprises a second pull-down sub-circuit 160 connected with the pull-up node PU, the output terminal OUT and a second pull-down node PD2, and configured to pull down the pull-up node PU and the output terminal OUT under control of a voltage level at the second pull-down node PD2.

Accordingly, the pull-up node PU and the output terminal OUT can be pulled down by the second pull-down sub-circuit under control of the second pull-down node, so that after the output period of the shift register unit, when the first clock signal is at a low voltage level, it is ensured that the pull-up node and the output terminal are at a low voltage level.

Optionally, as illustrated in FIG. 3, the shift register unit further comprises a second control sub-circuit 170 connected with the second clock signal terminal CLKB and the second pull-down node PD2, and configured to control a voltage level at the second pull-down node PD2 under control of a second clock signal provided at the second clock signal terminal CLKB.

Accordingly, the voltage level at the second pull-down node PD2 can be controlled by the second clock signal CLKB, so that the voltage level at the second pull-down node PD2 is pulled up when the CLKB outputs a high voltage level and the pull-up node PU is at a low voltage level, so as to turn on the second pull-down sub-circuit, and thereby it is ensured that the pull-up node PU and the output terminal are at a low voltage level.

According to the above embodiment, during the low voltage level maintaining period of the shift register unit, it can be ensured that the pull-up node and the output terminal are maintained in the low voltage level state through operations of the first pull-down sub-circuit and the second pull-down sub-circuit.

Optionally, as illustrated in FIG. 3, the shift register unit further comprises an output pull-down sub-circuit 180 connected with the second clock signal terminal CLKB and the output terminal OUT, and configured to pull down the output terminal OUT under control of the second clock signal terminal CLKB.

Accordingly, the output terminal of the shift register unit can be pulled down by the output pull-down sub-circuit under control of the second clock signal, so that the output terminal of the shift register unit outputs a low voltage level during a non-output period. In this way, reliability and redundancy of the system can be increased, and other transistors for pulling down the output terminal of the shift register unit can be downsized, reducing the cost.

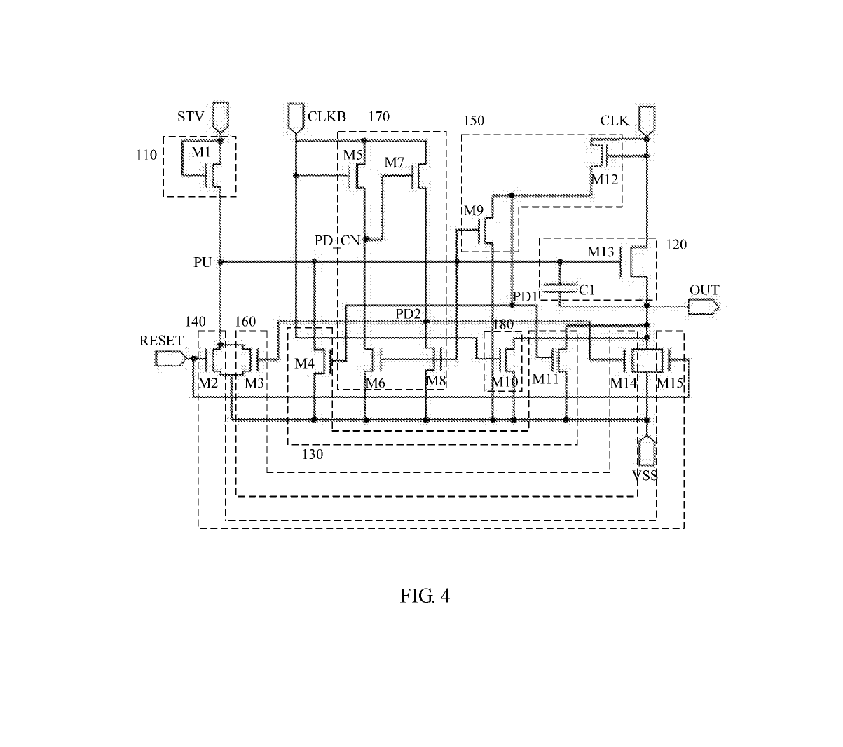

FIG. 4 illustrates schematic circuit structure of a shift register unit according to an embodiment of the present disclosure. The circuit structure of the shift register unit will be described in detail below with reference to FIG. 3 and FIG. 4.

Optionally, as illustrated in FIG. 4, the charging sub-circuit 110 comprises: a first TFT (thin film transistor) M1 having a first electrode and a second electrode connected with the input signal terminal INPUT, and a third electrode connected with the pull-up node PU.

Optionally, as illustrated in FIG. 4, the output sub-circuit 120 comprises: a second TFT M13 having a first electrode connected with the pull-up node PU, a second electrode connected with the first clock signal terminal CLK, and a third electrode connected with the output terminal OUT; and a capacitor C1 connected between the pull-up node and the output terminal.

Optionally, as illustrated in FIG. 4, the first pull-down sub-circuit 130 comprises: a third TFT M4 having a first electrode connected with the first pull-down node PD1, a second electrode connected with the pull-up node PU, and a third electrode connected with a low voltage level signal terminal VSS; and a fourth TFT M11 having a first electrode connected with the first pull-down node PD1, a second electrode connected with the output terminal OUT, and a third electrode connected with a low voltage level signal terminal VSS.

Optionally, as illustrated in FIG. 4, the reset sub-circuit 140 comprises: a fifth TFT M2 having a first electrode connected with the reset signal terminal RESET, a second electrode connected with the pull-up node, and a third electrode connected with a low voltage level signal terminal VSS; and a sixth TFT M15 having a first electrode connected with the reset signal terminal, a second electrode connected with the output terminal, and a third electrode connected with a low voltage level signal terminal VSS.

Optionally, as illustrated in FIG. 4, the first control sub-circuit 150 comprises: a seventh TFT M9 having a first electrode connected with the pull-up node PU, a second electrode connected with the first pull-down node PD1, and a third electrode connected with a low voltage level signal terminal VSS; and an eighth TFT M12 having a first electrode and a second electrode connected with the first clock signal terminal CLK, and a third electrode connected with the first pull-down node PD1.

Optionally, as illustrated in FIG. 4, the output pull-down sub-circuit 180 comprises: a ninth TFT M10 having a first electrode connected with the second clock signal terminal CLKB, a second electrode connected with the output terminal OUT, and a third electrode connected with a low voltage level signal terminal VSS.

Optionally, as illustrated in FIG. 4, the second pull-down sub-circuit 160 comprises: a tenth TFT M3 having a first electrode connected with the second pull-down node PD2, a second electrode connected with the pull-up node, and a third electrode connected with a low voltage level signal terminal VSS; and an eleventh TFT M14 having a first electrode connected with the second pull-down node PD2, a second electrode connected with the output terminal OUT, and a third electrode connected with a low voltage level signal terminal VSS.

Optionally, as illustrated in FIG. 4, the second control sub-circuit 170 comprises: a twelfth TFT M5, a thirteenth TFT M7, a fourteenth TFT M6 and a fifteenth TFT M8; a first electrode and a second electrode of the twelfth TFT M5 are connected with the second clock signal terminal CLKB, and a third electrode of the twelfth TFT M5 is connected with a first electrode of the thirteenth TFT; a second electrode of the thirteenth TFT M7 is connected with the second clock signal terminal, and a third electrode of the thirteenth TFT M7 is connected with the second pull-down node; a first electrode of the fourteenth TFT M6 is connected with the pull-up node, a second electrode of the fourteenth TFT M6 is connected with the first electrode of the thirteenth TFT, and a third electrode of the fourteenth TFT M6 is connected with a low voltage level signal terminal; and a first electrode of the fifteenth TFT M8 is connected with the pull-up node, a second electrode of the fifteenth TFT M8 is connected with the second pull-down node, and a third electrode of the fifteenth TFT M8 is connected with a low voltage level signal terminal VSS.

Optionally, in the shift register unit described above, the first electrode of the TFT is a gate, the second electrode of the TFT is a drain, and the third electrode of the TFT is a source.

In addition, it should be understood that, since the source and the drain of the TFT transistor adopted herein are symmetrical, the source and the drain thereof are interchangeable. In the embodiment of the present disclosure, in order to distinguish two electrodes other than the gate of a transistor, one of the two electrodes is referred to as a source and the other is referred to as a drain. If the source is selected as the signal input terminal, the drain then serves as the signal output terminal, and vice versa.

In addition, in FIG. 4, explanation is provided in a case in which all the TFTs adopt N-type TFTs as an example. However, it should be understood that a part of or all of the TFTs can adopt P-type TFTs, as long as a control voltage level at the gate thereof and a power voltage supplied thereto are adjusted accordingly, such implementations are also within the protection scope of the present disclosure.

In addition, although the low voltage level signal terminals are illustrated as all being connected with the low voltage level VSS in FIG. 4, in order to implement the principle of the present disclosure, the low voltage level signal terminals can be connected with different low voltage levels, for example, with low voltage levels VSS and VGL with different voltage values. For example, the low voltage level connected with the transistor for pulling down the output terminal of the shift register unit can be the low voltage level VGL, while the low voltage level connected with the transistor for pulling down the pull-up node of the shift register unit can be the low Voltage level VSS, wherein the voltage level of VGL is lower than the voltage level of VSS. In this way, a gate-source potential of the output transistor of the shift register unit can be reversely biased when the pull-up node and the output terminal are both pulled down to low voltage levels, even if the output transistor adopts a depletion transistor, it can be guaranteed that the output transistor is completely turned off.

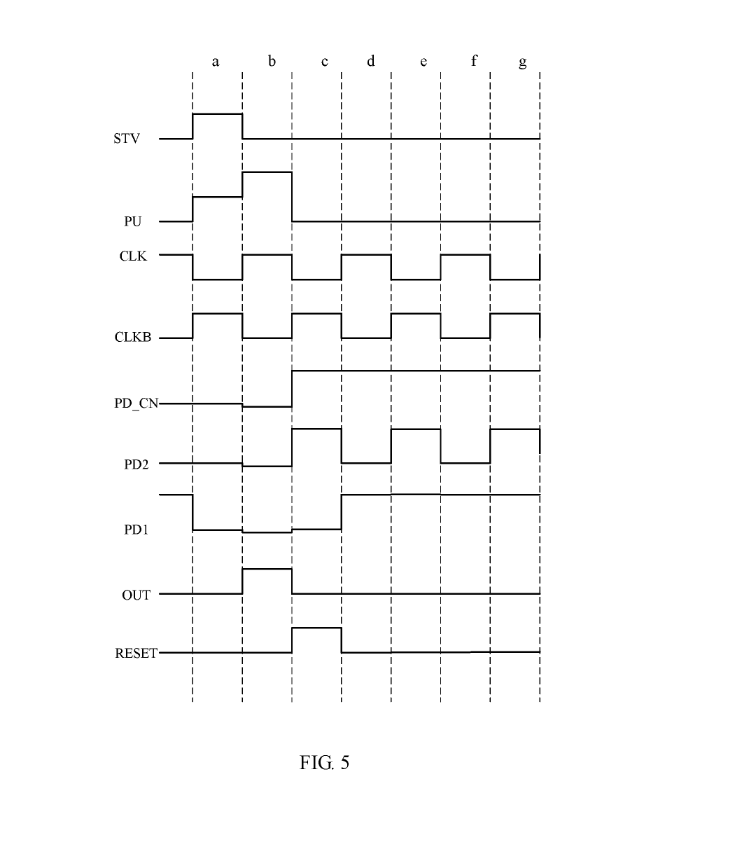

Next, with the shift register unit illustrated in FIG. 4 as an example, its specific operating principle will be described with reference to the signal timing illustrated in FIG. 5. The first clock signal terminal of the shift register unit is connected with the first clock signal CLK, the second clock signal terminal of the shift register unit is connected with the second clock signal CLKB, and the input terminal of the shift register unit is connected with the STV signal; optionally, STV represents a frame start signal in the case in which the shift register unit serves as the first stage, and STV represents an output signal from a previous-stage shift register unit connected in series with the shift register unit in the case in which the shift register unit serves as the other stages. In the five periods a, b, c, d, and e illustrated in FIG. 5, the shift register unit performs the following operations.

In the first period a, the clock signal CLK inputted at the first clock signal input terminal is at a low voltage level, the clock signal CLKB inputted at the second clock signal terminal is at a high voltage level, and STV inputted at the input terminal INPUT is at a high voltage level; since STV inputted at the input terminal INPUT is at a high voltage level, the transistor M1 is turned on, so that the input signal with a high voltage level charges the pull-up node to reach a first high voltage level; since the clock signal CLKB is at a high voltage level, the transistor M5 is turned on to charge the pull-down control node PD_CN; however, since the pull-up node PU is at the first high voltage level, transistors M6 and M8 are turned on; a size ratio of the transistors M5 and M6 can be configured such that the voltage level at the pull-down control node PD_CN is pulled down to a low voltage level when M5 and M6 are both turned on, so that the transistor M7 is not turned on; since the transistor M8 is turned on and the transistor M7 is turned off, the second pull-down node PD2 is pulled down to a low voltage level, and thereby it is ensured that the transistors M3 and M14 are in a turned-off state in this period; in addition, since the first clock signal CLK is at a low voltage level, M12 is turned off, the pull-up node PU is at a high voltage level, M9 is turned on, and thus the first pull-down node PD1 is pulled down to a low voltage level, the transistors M4 and M111 are turned off; since the pull-up node PU is at a high voltage level to charge the storage capacitor C1, so that the output transistor M13 is turned on to output the clock signal CLK with a low voltage level to the output terminal; in addition, since the second clock signal CLKB is at a high voltage level, the transistor M10 is turned on, and thereby it is ensured that the output terminal of the shift register unit is pulled downed to a low voltage level VSS.

In the second period b, the clock signal CLK inputted at the first clock signal terminal is at a high voltage level, the clock signal CLKB inputted at the second clock signal terminal is at a low voltage level, and STV at the input terminal INPUT is at a low voltage level; the transistors M1, M5 and M10 are turned off; the output transistor M13 remains on and outputs a first clock signal with a high voltage level to the output terminal; due to bootstrap effect of the storage capacitor C1, the potential at the pull-up node PU is further raised to a second high voltage level, so that the transistor M13 is turned on more fully; since the potential at the pull-up node PU is further raised, the transistors M6 and M8 are turned on more fully; since the transistor M5 is turned off, the voltage level at the pull-down control node PD_CN is pulled down to be lower; the transistor M7 still remains off, the voltage level at the second pull-down node PD2 is also pulled down to be lower; the transistors M3 and M14 still remain off so as not to affect the shift register unit to output the shift signal normally; since the first clock signal CLK is at a high voltage level, the transistor M12 is turned on; however, since the pull-up node PU is at a second high voltage level, the transistor M9 is turned on more fully, and the size ratio of the transistors M9 and M12 can be configured to pull down the first pull-down node PD1 to a low voltage level when M9 and M12 are both turned on; in this case, the voltage level at the first pull-down node PD1 is pulled down to be lower, the transistors M4 and M11 remain off, so that normal outputting of the shift signal by the shift register unit will not be affected.

In the third period c, the clock signal CLK inputted at the first clock signal terminal is at a low voltage level, the clock signal CLKB inputted at the second clock signal terminal is at a high voltage level, STV connected at the input terminal INPUT is at a low voltage level, the transistor M1 continues to remain off, and the transistor M10 is turned on under control of the CLKB with a high voltage level, so that the output terminal of the shift register unit is pulled down to VSS; since the reset signal terminal RESET is at a high voltage level, the transistors M2 and M15 are turned on to pull down the pull-up node PU and the output terminal, respectively; since the pull-up node PU is pulled down to VSS, the transistors M6, M8 and M13 are turned off, the capacitor C1 is discharged; since CLKB is at a high voltage level, the transistor M5 is turned on, and the pull-down control node PD_CN is charged, and thereby the pull-down control node PD_CN is charged to a high voltage level to turn on the transistor M7, and the second pull-down node PD2 is charged by the CLKB signal at a high voltage level via the turned-on transistor M7, so that the second pull-down node PD2 is also charged to a high voltage level; since the pull-up node PU is pulled down, the transistor M9 is turned off, and since CLK is at a low voltage level, the transistor M12 is also turned off, and the voltage level at the first pull-down node PD1 is slightly raised, but still remains at a low voltage level; since the first pull-down node PD1 is at a low voltage level, the transistors M4 and M11 remain off; however, since the second pull-down node PD2 is at a high voltage level, the transistors M3 and M14 are turned on, and thereby it is ensured that the pull-up node PU and the output terminal are pulled down.

In the fourth period d, the clock signal CLK inputted at the first clock signal terminal is at a high voltage level, the clock signal CLKB inputted at the second clock signal terminal is at a low voltage level, STV inputted at the input terminal INPUT is at a low voltage level, and the reset signal terminal RESET is at a low voltage level, the transistor M1 continues to remain off, the transistors M5, M10 are turned off; since the pull-up node PU remains at a low voltage level, the transistors M6, M8, M9 and M13 remain off; since the transistors M5 and M6 are both tuned off, a discharge path of the pull-down control node PD_CN is cut, the pull-down control node PD_CN maintains the previous high voltage level, the transistor M7 remains on, and the CLKB with a low voltage level is connected with the second pull-down node PD2 through the turned-on transistor M7; since CLK is at a high voltage level, the transistor M12 is turned on, the pull-up node PU is at a low voltage level, the transistor M9 is turned off, and thus the first pull-down node PD1 is charged via the turned-on transistor M12 to a high voltage level; the second pull-down node PD2 is at a low voltage level, the transistors M3 and M14 are turned off; however, since first pull-down node PD1 is at a high voltage level, the transistors M4 and M1 are turned on, and thus it is ensured that the pull-up node PU and the output terminal are pulled down, respectively. As can be seen, compared with the previous period, the transistor M4 replaces M3 to pull down the pull-up node, the transistor M11 replaces M14 to pull down the output terminal.

Compared with the shift register unit illustrated in FIG. 1, in the fourth period d, even if the coupling capacitance Cp exists, the transistor M12 is turned on due to the clock signal CLK at a high voltage level and the first pull-down node PD1 is charged to a high voltage level, so that the transistors M4 and M11 are turned on to pull down the pull-up node PU and the output terminal, respectively, eliminating the possible noise.

In the fifth period e, the clock signal CLK inputted at the first clock signal terminal is at a low voltage level, the clock signal CLKB inputted at the second clock signal terminal is at a high voltage level, STV connected with the input terminal INPUT is at a low voltage level, and the reset signal terminal is connected with a low voltage level; since STV is at a low voltage level, the transistor M1 continues to remain off; since CLKB is at a high voltage level, the transistors M5 and M10 are turned on; since the pull-up node PU remains at a low voltage level, the transistors M6, M8, M9 and M13 remain off; the pull-down control node PD_CN is connected with the clock signal CLKB with a high voltage level via the turned-on transistor M5, so as to maintain the previous high voltage level; the transistor M7 continues to be turned on, CLKB with a high voltage level is connected with the second pull-down node PD2, so that the second pull-down node PD2 becomes to be at a high voltage level; since CLK is at a low voltage level, the transistor M12 is turned off, the pull-up node PU is at a low voltage level, the transistor M9 remains off, a discharge path of the first pull-down node PD1 is cut, and the first pull-down node PD1 maintains the previous high voltage level; in this case, since the first pull-down node PD1 maintains a high voltage level, the transistors M4 and M11 remain on, so that the pull-up node PU and the output terminal are pulled down, respectively; in addition, since the second pull-down node PD2 is also at a high voltage level, the transistors M3 and M14 are also turned on, so as to ensure that the pull-up node PU and the output terminal are pulled down, respectively.

The subsequent periods will repeat operations in the fourth period and the fifth period, until the next STV signal with a high voltage level arrives.

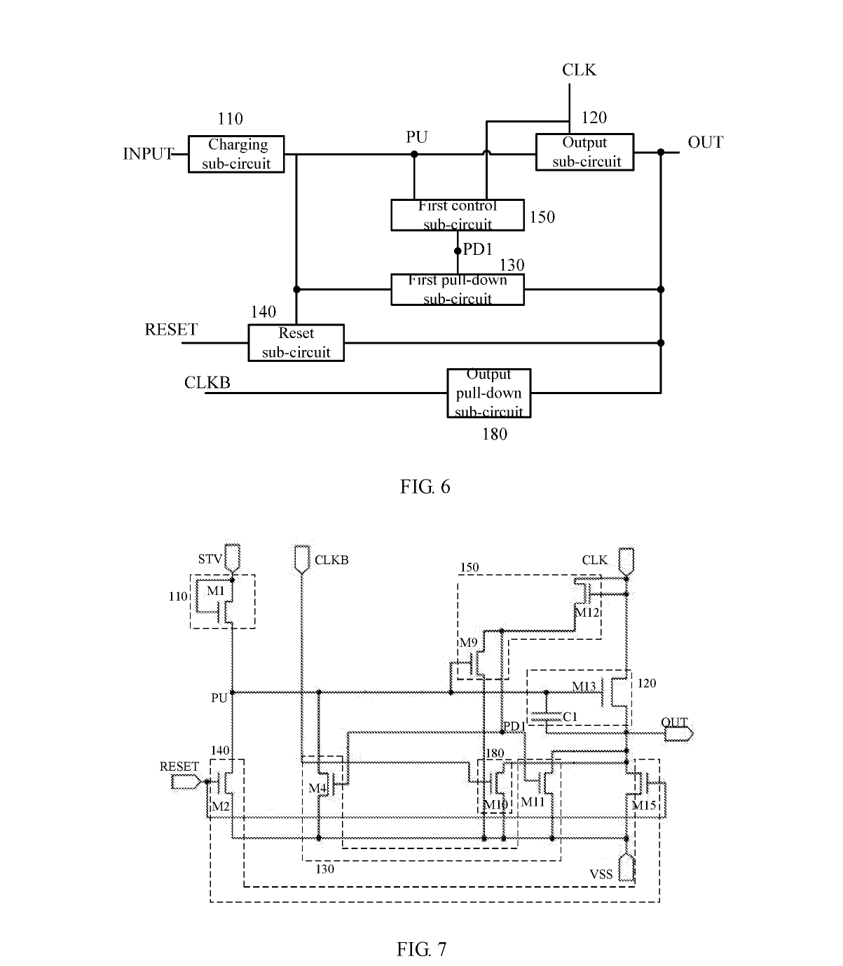

According to another embodiment of the present disclosure, the shift register unit illustrated in FIG. 3 can also be simplified. As illustrated in FIG. 6, the shift register unit comprises: a charging sub-circuit 110 connected between an input signal terminal INPUT and a pull-up node PU, and configured to charge the pull-up node PU under control of a signal inputted at the input signal terminal; an output sub-circuit 120 connected between the pull-up node PU, a first clock signal terminal CLK and an output terminal OUT, and configured to output, via the output terminal, a clock signal provided by the first clock signal terminal as a driving signal under control of a voltage level at the pull-up node PU; a first pull-down sub-circuit 130 connected with the pull-up node PU, the output terminal OUT and a first pull-down node PD1, and configured to pull down the pull-up node PU and the output terminal OUT under control of a voltage level at the first pull-down node PD1; and a reset sub-circuit 140 connected with the pull-up node PU, the output terminal OUT and a reset signal terminal RESET, and configured to reset the pull-up node PU and the output terminal OUT under control of a reset signal inputted at the reset signal terminal.

Optionally, as illustrated in FIG. 6, the shift register unit further comprises: a first control sub-circuit 150 connected with the pull-up node PU, the first clock signal terminal CLK and the first pull-down node PD1, and configured to control a voltage level at the first pull-down node PD1 under control of voltage levels at the pull-up node PU and the first clock signal terminal CLK.

Optionally, as illustrated in FIG. 6, the shift register unit further comprises: an output pull-down sub-circuit 180 connected with a second clock signal terminal CLKB and the output terminal OUT, and configured to pull down the output terminal OUT under control of the second clock signal terminal CLKB.

As can be seen, the main difference with respect to the shift register unit illustrated in FIG. 3 is that the shift register unit can exclude the second pull-down sub-circuit and the second control sub-circuit.

In the above-described shift register unit according to the present disclosure, since the first pull-down sub-circuit 130 is configured, in the low voltage level maintaining period during the driving process of the shift register unit, the pull-up node PU and the output terminal OUT can be pulled down according to the voltage level at the first pull-down node PD1, which eliminates the noise caused by presence of the coupling capacitance, and thereby it is ensured that a correct driving signal is outputted to the gate line connected with the shift register unit, and finally the quality of the pixel display is guaranteed.

In addition, since the first control sub-circuit is arranged, the voltage level at the first pull-down node PD1 can be controlled by the first clock signal CLK, so that when the CLK outputs a high voltage level and the pull-up node PU is at a low voltage level, the voltage level at the first pull-down node PD1 is pulled up, so as to turn on the first pull-down sub-circuit, thereby eliminating the noises at the pull-up node PU and the output terminal due to the coupling capacitance.

According to the above embodiment, during the low voltage level maintaining period of the shift register unit, it can be ensured that the pull-up node and the output terminal are maintained in the low voltage level state through operations of the first pull-down sub-circuit.

In addition, during the charging period of the pull-up node PU, the output terminal of the shift register unit can be pulled down by the output pull-down sub-circuit under control of the second clock signal, so that the output terminal of the shift register unit outputs a low voltage level in this period.

FIG. 7 illustrates a schematic circuit structure of a shift register unit according to another embodiment of the present disclosure. The circuit structure of the shift register unit will be described in detail below with reference to FIG. 6 and FIG. 7.

Optionally, as illustrated in FIG. 7, the charging sub-circuit 110 comprises: a first TFT (thin film transistor) M1 having a first electrode and a second electrode connected with the input signal terminal INPUT, and a third electrode connected with the pull-up node PU.

Optionally, as illustrated in FIG. 7, the output sub-circuit 120 comprises: a second TFT M13 having a first electrode connected with the pull-up node PU, a second electrode connected with the first clock signal terminal CLK, and a third electrode connected with the output terminal OUT; and a capacitor C1 connected between the pull-up node and the output terminal.

Optionally, as illustrated in FIG. 7, the first pull-down sub-circuit 130 comprises: a third TFT M4 having a first electrode connected with the first pull-down node PD1, a second electrode connected with the pull-up node, and a third electrode connected with a low voltage level signal terminal VSS; and a fourth TFT M11 having a first electrode connected with the first pull-down node PD1, a second electrode connected with the output terminal OUT, and a third electrode connected with a low voltage level signal terminal VSS.

Optionally, as illustrated in FIG. 7, the reset sub-circuit 140 comprises: a fifth TFT M2 having a first electrode connected with the reset signal terminal RESET, a second electrode connected with the pull-up node, and a third electrode connected with a low voltage level signal terminal VSS; and a sixth TFT M15 having a first electrode connected with the reset signal terminal, a second electrode connected with the output terminal, and a third electrode connected with a low voltage level signal terminal VSS.

Optionally, as illustrated in FIG. 7, the first control sub-circuit 150 comprises: a seventh TFT M9 having a first electrode connected with the pull-up node PU, a second electrode connected with the first pull-down node PD1, and a third electrode connected with a low voltage level signal terminal VSS; and an eighth TFT M12 having a first electrode and a second electrode connected with the first clock signal terminal CLK, and a third electrode connected with the first pull-down node PD1.

Optionally, as illustrated in FIG. 7, the output pull-down sub-circuit 180 comprises: a ninth TFT M10 having a first electrode connected with the second clock signal terminal CLKB, a second electrode connected with the output terminal OUT, and a third electrode connected with a low voltage level signal terminal VSS.

Compared with the shift register unit circuit illustrated in FIG. 4, the shift register unit circuit illustrated in FIG. 7 removes the second pull-down sub-circuit and the second control sub-circuit, so that the circuit configuration is simplified.

Optionally, in the shift register unit described above, the first electrode of the TFT is a gate, the second electrode of the TFT is a drain, and the third electrode of the TFT is a source.

In addition, it should be understood that, since the source and the drain of the TFT transistor adopted herein are symmetrical, the source and the drain thereof are interchangeable. In the embodiment of the present disclosure, in order to distinguish two electrodes other than the gate of a transistor, one of the two electrodes is referred to as a source and the other is referred to as a drain. If the source is selected as the signal input terminal, the drain then serves as the signal output terminal, and vice versa.

In addition, in FIG. 7, explanation is provided in a case in which all the TFTs adopt N-type TFTs as an example. However, it should be understood that a part of or all of the TFTs can adopt P-type TFTs, as long as a control voltage level at the gate thereof and a power voltage supplied thereto are adjusted accordingly, such implementations are also within the protection scope of the present disclosure.

In addition, the low voltage level signal terminals are illustrated as all being connected with the low voltage level VSS in FIG. 7, however, in order to implement the principle of the present disclosure, the low voltage level signal terminals can be connected with different low voltage levels, for example, with low voltage levels VSS and VGL with different voltage values. For example, the low voltage level connected with the transistor for pulling down the output terminal of the shift register unit can be the low voltage level VGL, while the low voltage level connected with the transistor for pulling down the pull-up node of the shift register unit can be the low voltage level VSS, wherein the voltage level of VGL is lower than the voltage level of VSS. In this way, a gate-source potential of the output transistor of the shift register unit can be reversely biased when the pull-up node and the output terminal are both pulled down to low voltage levels; even if the output transistor adopts a depletion transistor, it can be guaranteed that the output transistor is completely turned off.

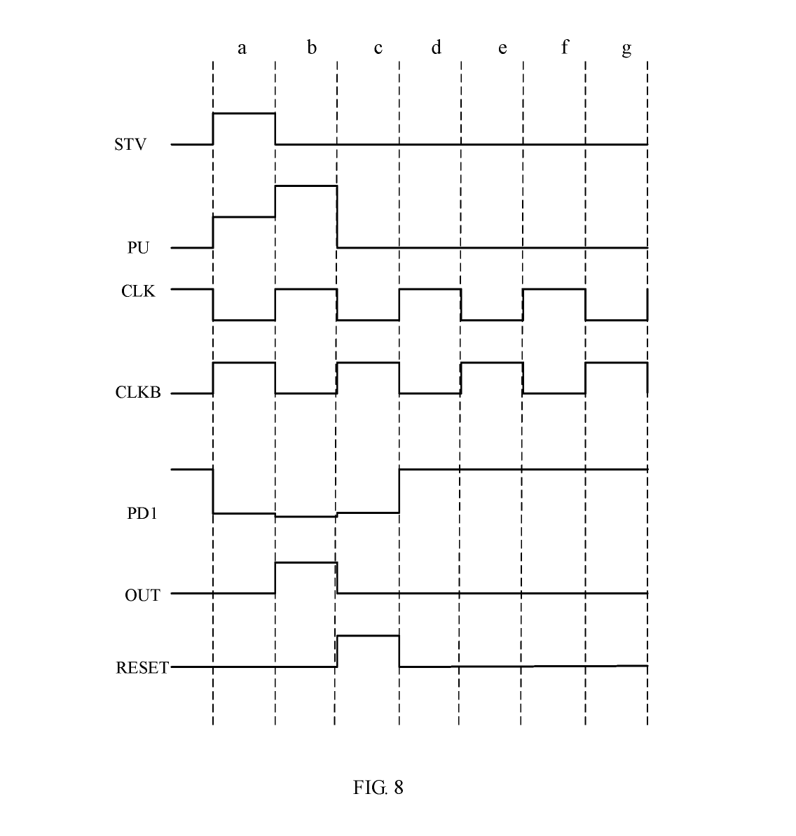

Next, with the shift register unit illustrated in FIG. 7 as an example, its specific operating principle will be described with reference to the signal timing illustrated in FIG. 8. The first clock signal terminal of the shift register unit is connected with the first clock signal CLK, the second clock signal terminal of the shift register unit is connected with the second clock signal CLKB, and the input terminal of the shift register unit is connected with the STV signal; optionally, STV represents a frame start signal in a case in which the shift register unit serves as the first stage, and STV represents an output signal from a previous-stage shift register unit connected in series with the shift register unit in a case in which the shift register unit serves as the other stages. In the five periods a, b, c, d, and e illustrated in FIG. 8, the shift register unit performs the following operations.

In the first period a, the clock signal CLK inputted at the first clock signal input terminal is at a low voltage level, the clock signal CLKB inputted at the second clock signal terminal is at a high voltage level, and STV inputted at the input terminal INPUT is at a high voltage level; since STV inputted at the input terminal INPUT is at a high voltage level, the transistor M1 is turned on, so that the input signal with a high voltage level charges the pull-up node to reach a first high voltage level; since the first clock signal CLK is at a low voltage level, M12 is turned off; the pull-up node PU is at a high voltage level, M9 is turned on, and thus the first pull-down node PD1 is pulled down to a low voltage level, the transistors M4 and M11 are turned off; since the pull-up node PU is at a high voltage level to charge the storage capacitor C1, so that the output transistor M13 is turned on to output the clock signal CLK with a low voltage level to the output terminal; in addition, since the second clock signal CLKB is at a high voltage level, the transistor M10 is turned on, and thereby it is ensured that the output terminal of the shift register unit is pulled down to a low voltage level VSS.

In the second period b, the clock signal CLK inputted at the first clock signal terminal is at a high voltage level, the clock signal CLKB inputted at the second clock signal terminal is at a low voltage level, and STV connected with the input terminal INPUT is at a low voltage level; the transistors M1 and M10 are turned off; the output transistor M13 remains on and outputs a first clock signal with a high voltage level to the output terminal; due to bootstrap effect of the storage capacitor C1, the potential at the pull-up node PU is further raised to a second high voltage level, so that the transistor M13 is turned on more fully, ensuring the charging of pixel connected to the gate line; since the first clock signal CLK is at a high voltage level, the transistor M12 is turned on; however, since the pull-up node PU is further raised to the second high voltage level, the transistor M9 is turned on more fully, and in design of transistors, the size ratio of the transistors M9 and M12 can be configured so that the first pull-down node PD1 is pulled down to a low voltage level when M9 and M12 are both turned on; in this case, the voltage level at the first pull-down node PD1 is pulled down to be lower and the transistors M4 and M11 remain off, so that normal outputting of the shift signal by the shift register unit will not be affected.

In the third period c, the clock signal CLK inputted at the first clock signal terminal is at a low voltage level, the clock signal CLKB inputted at the second clock signal terminal is at a high voltage level, STV connected at the input terminal INPUT is at a low voltage level, and the transistor M1 remains off; the transistor M10 is turned on under control of the CLKB with a high voltage level, so that the output terminal of the shift register unit is pulled down to VSS; since the reset signal terminal RESET is at a high voltage level, the transistors M2 and M15 are turned on, to pull down the pull-up node PU and the output terminal, respectively; since the pull-up node PU is pulled down to VSS, the capacitor C1 is discharged; since the pull-up node PU is pulled down, the transistor M9 is turned off, and since CLK is at a low voltage level, the transistor M12 is also turned off, and the voltage level at the first pull-down node PD1 is slightly raised, but still remains at a low voltage level; since the first pull-down node PD1 is at a low voltage level, the transistors M4 and M11 remain off, however, since a high voltage level is inputted at the reset signal terminal, the transistors M2 and M15 are turned on, and thereby it is ensured that the pull-up node PU and the output terminal are pulled down.

In the fourth period d, the clock signal CLK inputted at the first clock signal terminal is at a high voltage level, the clock signal CLKB inputted at the second clock signal terminal is at a low voltage level, STV inputted at the input terminal INPUT is at a low voltage level, and the reset signal terminal RESET is at a low voltage level, the transistor M1 continues to remain off, and the transistor M10 is turned off; since the pull-up node PU remains at a low voltage level, the transistor M13 remains off; since CLK is at a high voltage level, the transistor M12 is turned on; the pull-up node PU is at a low voltage level, and the transistor M9 is turned off; thus the first pull-down node PD1 is charged via the turned-on transistor M12 to a high voltage level; since the first pull-down node PD1 is at a high voltage level, the transistors M4 and M11 are turned on, so that it is ensured that pull-up node PU and the output terminal are pulled down, respectively.

Compared with the shift register unit illustrated in FIG. 1, in the fourth period d, even if the coupling capacitance Cp exists, the transistor M12 is turned on due to the clock signal CLK at a high voltage level, and the first pull-down node PD1 is charged to a high voltage level, so that the transistors M4 and M11 are turned on to pull down the pull-up node PU and the output terminal, respectively, eliminating the possible noise.

In the fifth period e, the clock signal CLK inputted at the first clock signal terminal is at a low voltage level, the clock signal CLKB inputted at the second clock signal terminal is at a high voltage level, STV inputted at the input terminal INPUT is at a low voltage level, and the reset signal terminal is connected with a low voltage level; since STV is at a low voltage level, the transistor M1 continues to remain off; since CLKB is at a high voltage level, the transistor M10 is turned on; since the pull-up node PU maintains a low voltage level, the transistor M13 remains off; since CLK is at a low voltage level, the transistor M12 is turned off; the pull-up node PU is at a low voltage level, and the transistor M9 remains off; a discharge path of the first pull-down node PD1 is cut, the first pull-down node PD1 maintains the previous high voltage level; in this case, since the first pull-down node PD1 remains at a high voltage level, the transistors M4 and M1 remain on, so that the pull-up node PU and the output terminal are pulled down, respectively.

The subsequent periods will repeat operations in the fourth period and the fifth period, until the next STV signal with a high voltage level arrives.

As can be seen, according to the shift register unit circuit illustrated in FIG. 7, it is also possible to eliminate the noise caused by the coupling capacitance during the low-voltage level remaining period of the shift register unit.

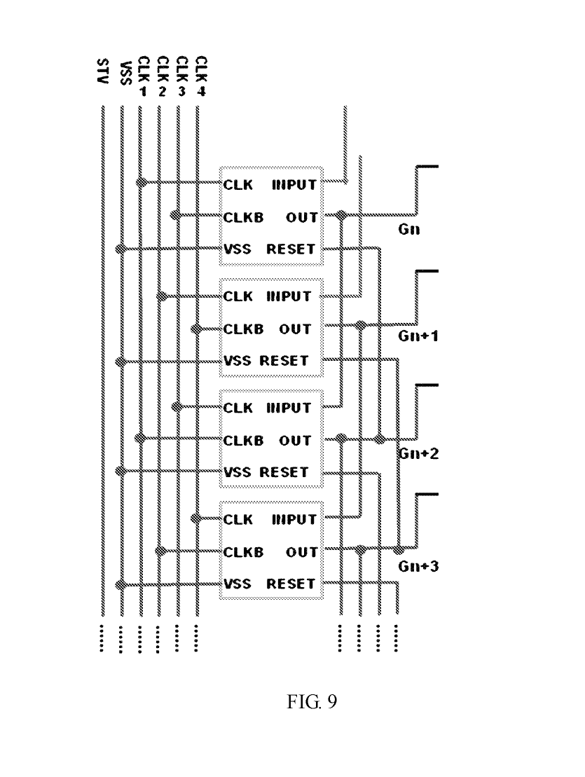

According to another aspect of the present disclosure, there is also provided a gate line driving device. As illustrated in FIG. 9, the gate line driving device comprises a plurality of stages of the shift register unit described above.

Optionally, an output terminal of shift register unit at each stage is connected with one gate line; shift register units at odd-numbered stages are connected with first and third clock signals; shift register units at even-numbered stages are connected with second and fourth clock signals; shift register units at odd-numbered stages are connected in series with each other, shift register units at even-numbered stages are connected in series with each other; in the shift register units that are connected in series at two stages, a clock signal inputted at a first clock signal terminal and a clock signal inputted at the second clock signal terminal are exchanged, an output terminal of the shift register unit at a previous stage is connected with an input signal terminal of the shift register unit at a next stage, and a reset signal terminal of the shift register unit at the previous stage is connected with an output terminal of the shift register unit at the next stage. As illustrated in FIG. 9, taking the shift register unit at an N-th stage as an example, the output terminal OUTPUT of the shift register unit at the N-th stage is connected with the N-th gate line G(n) and the input signal terminal INPUT of the shift register unit at an (N+2)-th stage, an input terminal of the shift register unit in the N-th stage is connected with the output terminal OUT of the shift register unit at the (n−2)-th stage, and a reset signal terminal RESET of the shift register unit in an N-th stage is connected with the output terminal of the shift register unit at an (N+2)-th stage.

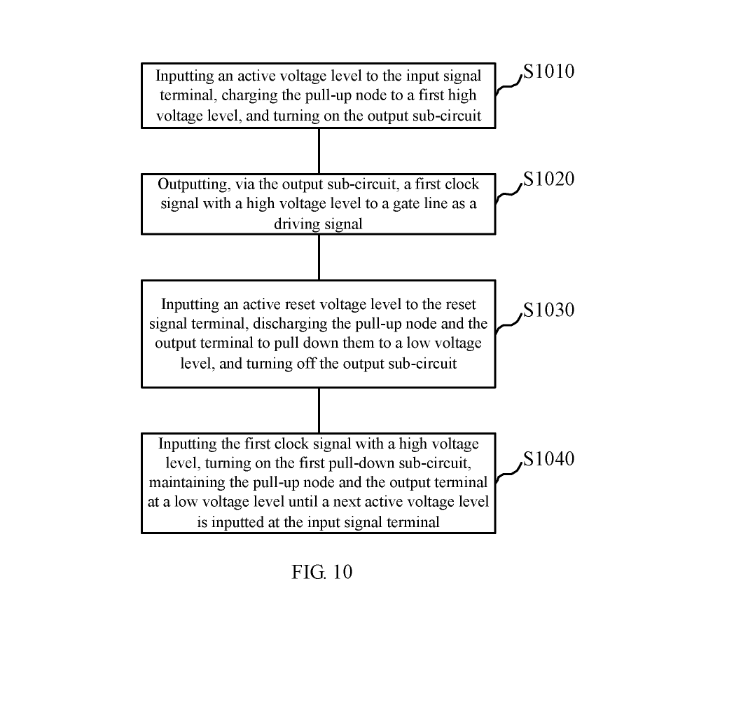

According to still another aspect of the present disclosure, there is also provided a method for driving control of the shift register unit illustrated in FIG. 3 or 6. As illustrated in FIG. 10, the method mainly comprises the following steps: step S1010, inputting an active voltage level to the input signal terminal, charging the pull-up node to a first high voltage level, and turning on the output sub-circuit; S1020, outputting, via the output sub-circuit, a first clock signal with a high voltage level to a gate line as a driving signal; S1030; inputting an active reset voltage level to the reset signal terminal, discharging the pull-up node and the output terminal and pulling down the same to a low voltage level, and turning off the output sub-circuit; S1040, inputting the first clock signal with a high voltage level, turning on the first pull-down sub-circuit, maintaining the pull-up node and the output terminal at a low voltage level until a next active voltage level is inputted at the input signal terminal.

Optionally, in step S1010, a second clock signal at a high voltage level is inputted to pull down the output terminal.

Optionally, in step S1040, the first control sub-circuit is turned on by inputting a first clock signal at a high voltage level, to charge the first pull-down node, so as to turn on the first pull-down sub-circuit.

In the driving method for the shift register unit according to an embodiment of the present disclosure, the first control sub-circuit is turned on by the first clock signal during the low-voltage level maintaining period of the shift register unit to charge the first pull-down node, so that the first pull-down sub-circuit is turned on to pull down the pull-up node and the output terminal, so as to eliminate noise caused by the coupling capacitance, improve a signal waveform outputted to the gate line, and improve a display quality of pixel.

The above described merely are specific implementations of the present disclosure, but the protection scope of the present disclosure is not limited thereto, modification and replacements easily conceivable for those skilled in the art within the technical range revealed by the present disclosure all fall into the protection scope of the present disclosure. Therefore, the protection scope of the present disclosure should be determined based on the protection scope of the claims.

The present application claims priority of the Chinese Patent Application No. 201610371835.7 filed on May 30, 2016, the entire disclosure of which is hereby incorporated as a whole by reference as part of the present application.

1. A shift register circuit, comprising:
a charging sub-circuit connected with an input signal terminal and a pull-up node, and configured to charge the pull-up node under control of a signal inputted at the input signal terminal;
an output sub-circuit connected with the pull-up node, a first clock signal terminal and an output terminal, and configured to output, via the output terminal, a clock signal provided by the first clock signal terminal as a driving signal under control of a voltage level at the pull-up node;
a first pull-down sub-circuit connected with the pull-up node, the output terminal and a first pull-down node, and configured to pull down the pull-up node and the output terminal under control of a voltage level at the first pull-down node;
a reset sub-circuit connected with the pull-up node, the output terminal and a reset signal terminal, and configured to reset the pull-up node and the output terminal under control of a reset signal inputted at the reset signal terminal; and
a first control sub-circuit connected with the pull-up node, the first clock signal terminal and the first pull-down node, and configured to control a voltage level at the first pull-down node under control of voltage levels at the pull-up node and the first clock signal terminal.

2. The shift register circuit according to claim 1, further comprising:
an output pull-down sub-circuit connected with a second clock signal terminal and the output terminal, and configured to pull down the output terminal under control of the second clock signal terminal.

3. The shift register circuit according to claim 1, further comprising:
a second pull-down sub-circuit connected with the pull-up node, the output terminal and a second pull-down node, and configured to pull down the pull-up node and the output terminal under control of a voltage level at the second pull-down node.

4. The shift register circuit according to claim 1, further comprising:
a second control sub-circuit connected with the second clock signal terminal and the second pull-down node, and configured to control a voltage level at the second pull-down node under control of a second clock signal provided at the second clock signal terminal.

5. The shift register circuit according to claim 1, wherein the charging sub-circuit comprises:
a first thin film transistor (TFT) having a first electrode and a second electrode connected with the input signal terminal, and a third electrode connected with the pull-up node.

6. The shift register circuit according to claim 1, wherein the output sub-circuit comprises:
a second TFT having a first electrode connected with the pull-up node, a second electrode connected with the first clock signal terminal, and a third electrode connected with the output terminal; and
a capacitor connected between the pull-up node and the output terminal.

7. The shift register circuit according to claim 1, wherein the first pull-down sub-circuit comprises:
a third TFT having a first electrode connected with the first pull-down node, a second electrode connected with the pull-up node, and a third electrode connected with a low voltage level signal terminal; and
a fourth TFT having a first electrode connected with the first pull-down node, a second electrode connected with the output terminal, and a third electrode connected with a low voltage level signal terminal.

8. The shift register circuit according to claim 1, wherein the reset sub-circuit comprises:
a fifth TFT having a first electrode connected with the reset signal terminal, a second electrode connected with the pull-up node, and a third electrode connected with a low voltage level signal terminal; and
a sixth TFT having a first electrode connected with the reset signal terminal, a second electrode connected with the output terminal, and a third electrode connected with a low voltage level signal terminal.

9. The shift register circuit according to claim 1, wherein the first control sub-circuit comprises:
a seventh TFT having a first electrode connected with the pull-up node, a second electrode connected with the first pull-down node, and a third electrode connected with a low voltage level signal terminal; and
an eighth TFT having a first electrode and a second electrode connected with the first clock signal terminal, and a third electrode connected with the first pull-down node.

10. The shift register circuit according to claim 2, wherein the output pull-down sub-circuit comprises:
a ninth TFT having a first electrode connected with the second clock signal terminal, a second electrode connected with the output terminal, and a third electrode connected with a low voltage level signal terminal.

11. The shift register circuit according to claim 3, wherein the second pull-down sub-circuit comprises:
a tenth TFT having a first electrode connected with the second pull-down node, a second electrode connected with the pull-up node, and a third electrode connected with a low voltage level signal terminal; and
an eleventh TFT having a first electrode connected with the second pull-down node, a second electrode connected with the output terminal, and a third electrode connected with a low voltage level signal terminal.

12. The shift register circuit according to claim 4, wherein the second control sub-circuit comprises a twelfth TFT, a thirteenth TFT, a fourteenth TFT and a fifteenth TFT;
a first electrode and a second electrode of the twelfth TFT are connected with the second clock signal terminal, and a third electrode of the twelfth TFT is connected with a first electrode of the thirteenth TFT;
a second electrode of the thirteenth TFT is connected with the second clock signal terminal, and a third electrode of the thirteenth TFT is connected with the second pull-down node;
a first electrode of the fourteenth TFT is connected with the pull-up node, a second electrode of the fourteenth TFT is connected with the first electrode of the thirteenth TFT, and a third electrode of the fourteenth TFT is connected with a low voltage level signal terminal; and
a first electrode of the fifteenth TFT is connected with the pull-up node, a second electrode of the fifteenth TFT is connected with the second pull-down node, and a third electrode of the fifteenth TFT is connected with a low voltage level signal terminal.

13. A gate line driving circuit, comprising a plurality of stages of the shift register circuit according to claim 1.

14. The gate line driving circuit according to claim 13, wherein an output terminal of shift register circuit at each stage is connected with one gate line; shift register circuits at odd-numbered stages are connected with first and third clock signals; shift register circuits at even-numbered stages are connected with second and fourth clock signals; shift register circuits at odd-numbered stages are connected in series with each other, shift register circuits at even-numbered stages are connected in series with each other; in the shift register circuits that are connected in series at two stages, a clock signal inputted at a first clock signal terminal and a clock signal inputted at the second clock signal terminal are exchanged, an output terminal of the shift register circuit at a previous stage is connected with an input signal terminal of the shift register circuit at a next stage, and a reset signal terminal of the shift register circuit at the previous stage is connected with an output terminal of the shift register circuit at the next stage.

15. An array substrate, comprising the gate line driving circuit according to claim 13.

16. A driving method applied to a shift register circuit comprising a charging sub-circuit connected with an input signal terminal and a pull-up node; an output sub-circuit connected with the pull-up node, a first clock signal terminal and an output terminal; a first pull-down sub-circuit connected with the pull-up node, the output terminal and a first pull-down node; a reset sub-circuit connected with the pull-up node, the output terminal and a reset signal terminal; and a first control sub-circuit connected with the pull-up node, the first clock signal terminal and the first pull-down node;
wherein the driving method comprises:
inputting an active voltage level to the input signal terminal, charging the pull-up node to a first high voltage level, and turning on the output sub-circuit;
outputting, via the output sub-circuit, a first clock signal with a high voltage level to a gate line as a driving signal;
inputting an active reset voltage level to the reset signal terminal, discharging the pull-up node and the output terminal to pull down them to a low voltage level, and turning off the output sub-circuit; and
inputting the first clock signal with a high voltage level, turning on the first pull-down sub-circuit, maintaining the pull-up node and the output terminal at a low voltage level until a next active voltage level is inputted at the input signal terminal.

17. The driving method according to claim 16, wherein a second clock signal of a high voltage level is inputted to pull down the output terminal when the pull-up node is charged.

18. The driving method according to claim 16, wherein a first clock signal of a high voltage level is inputted, and the first control sub-circuit is turned on to charge the first pull-down node, so as to turn on the first pull-down sub-circuit.
